(19) United States
(12) Patent Application Publication
(10) Pub. No.: US 2025/0154365 A1
(43) Pub. Date: May 15, 2025

(54) DEEP EUTECTIC SOLVENT ADDITIVES

(71) Applicant: Dunn-Edwards Corporation, Commerce, CA (US)

(72) Inventors: Allen Bulick, Long Beach, CA (US); Qining Sun, Franklin, TN (US); Kelli Huber-Gonzales, Long Beach, CA (US); Jeff Locke, Bastrop, TX (US); Chris Wessels, San Clemente, CA, CA (US)

(21) Appl. No.: 17/936,870

(22) Filed: Sep. 30, 2022

(51) Int. Cl. C09D 7/20; C09D 5/02

(52) U.S. Cl. CPC C09D 7/20; C09D 5/028

(57) ABSTRACT

Low to zero volatile organic compounds (VOC) paints and coatings incorporate deep eutectic solvents (DES) to extend open time and stabilize pigments and colorants. Reduction of VOCs provides improved environmental, health, and safety benefits. In embodiments a pigment, binder, and water are combined with a deep eutectic solvent blend comprising an ionic solvent with one or more hydrogen bond donors and one or more hydrogen bond acceptors. In embodiments, the melting point of the deep eutectic solvent blend is lower than the individual components.

### BACKGROUND

Reduction of volatile organic compounds (VOCs) in water-based paints and coatings has been an industry trend for many years as part of an effort to improve the environmental, health, and safety profile of their products. While significant technology advancements have been made to develop high performing products, several limitations persist. In particular, coating open time is frequently cited as a deficiency in low VOC products. Previous attempts low VOC open time additives tend to carry one or more limitations including high usage levels, high cost, water sensitivity, and reduction of surface hardness properties. There is a need for new technologies that deliver improved application properties without contributing to coating VOC.

### SUMMARY

This Summary is intended to introduce, in an abbreviated form, various topics to be elaborated upon below in the Detailed Description. This Summary is not intended to identify key or essential aspects of the claimed invention. This Summary is similarly not intended for use as an aid in determining the scope of the claims.

A coating composition includes a pigment, a binder, water, and a deep eutectic solvent blend comprising an ionic solvent with at least one hydrogen bond donor and at least one hydrogen bond acceptor, wherein the melting point of the deep eutectic solvent blend is lower than either individual component.

Implementations may further include any of a dispersing agent, a wetting agent, or a neutralizing agent.

Implementations may further include compositions where the total solid content of the DES system is more than about 70% by weight, where the melting temperature of the composition is below 100° C., or where the melting temperature of the composition is not more than 50° C.

Further implementations may include a pseudo deep eutectic solvent blend having same ingredients in the same mole ratio as the DES system without forming eutectic mixtures where the total solid content of the pseudo deep eutectic solvent blend is more than about 70% by weight.

Further implementations may include additives such as dispersing agents, wetting agents, leveling agents, neutralizing agents, rheology modifiers, freeze/thaw stabilizers, corrosion inhibitors, biocides, mildewcides, coalescing agents, and defoamers.

Further implementations may include pigments selected from the group consisting of: primary and extender white pigments, metallic pigments, colored pigments in both inorganic and organic compounds, and functional pigments providing slip resistance, antifouling protection against mold, mildew or bacteria, UV stabilization, corrosion resistance or other desired properties.

Further implementations may include binders such as water-based acrylics, alkyds, epoxies, polyurethanes, polyesters, silicones, and vinyl acrylics.

Further implementations may include a specific organic salt including quaternary ammonium salt, quaternary imidazolium salt, a phosphonium salt. or a tertiary sulfonium salt.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates to be drafted after the figures are finalized; and

FIG. 2 illustrates to be drafted after the figures are finalized.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention, which is limited only by the appended claims.

Embodiments disclosed herein may include an incorporation or use of deep eutectic solvents (DES) as novel additives, for example, in low to zero volatile organic compounds (VOC) paints and coatings, which may extend open time and stabilize pigments and colorants.

Conventionally, several challenges of formulating and applying waterborne architectural coatings stand unaddressed, including, for example: (1) how to make paints at higher gloss levels with more resin and less pigment and zero VOCs, which can still coalesce appropriately at room temperature and dry to a hard, durable finish; (2) how to guarantee enough open time for a good workability in low humidity and high temperature environments without the presence of slow-evaporating solvents; (3) how to preserve finished paints and ingredients against biological contamination for longer periods of time with reduced VOC levels; and (4) how to develop products with easy-to-apply new looks, reduced chemical concerns and improved film properties. Traditional approaches to produce low VOC open time additives typically rely on hygroscopic oligomeric or polymeric structures of poly(ethylene) oxide (PEO) and various functionalized derivatives (e.g. SOLVAY RHODOLINE® OTE 600 and LUBRIZOL HUMECTANT GRB4). These materials function by slowing water evaporation via hydrogen bonding. Once the coating has dried, these materials persist in the film and retain their water sensitivity. In instances of rain or washing, these materials may reabsorb water into the coating film, causing blistering or film removal. They tend to be used at high levels (e.g. >0.5 wt. % or >1 wt. % on total formulation) which has a significant impact on formulation raw material cost. Additionally, they may negatively impact surface hardness properties such as tackiness and block resistance.

With increasing pressure from government and industry regulators to drive VOC levels downward in waterborne coatings and demand for low odor and low-cytotoxic coatings, solutions that enhance paint workability without contributing VOCs and negatively impacting paint stability and film properties may be desirable to achieve an acceptable balance of properties and performances both during application and in a final film. In response, research in biotechnological processes has centered on DESs, in particular, natural deep eutectic solvents (NADES). NADESs are of interest due to their environmental friendliness, tuneability, biodegradability, renewability, scalability, low cost, and simple preparation compared to other conventional organic solvents.

As a class of ionic liquid analogues, DESs are formed from a eutectic mixture of Lewis or Brønsted acids and bases which can contain a variety of anionic and/or cationic species different from ionic liquids (ILs) composed primarily of one type of discrete anion and cation. DESs can be described by the general formula Cat⁺X⁻zY, where Cat⁺ may be in principle any ammonium, phosphonium, or sulfonium cation, and X may be a Lewis base, along with the complex anionic species formed between X⁻ and either a Lewis or Brønsted acid Y (z refers to the number of Y molecules that interact with the anion). In most cases, DESs may be obtained by the complexation of a hydrogen acceptor (HBA), such as choline derivatives, with a metal salt or hydrogen-bond donor (HBD), such as an alcohol, leading to a significant depression of the freezing point of the mixture relative to the freezing points of the individual components. This property is attributed to the charge delocalization occurring through hydrogen bonding among the large and nonsymmetric ions and hydrogen-donor moiety, which may thereby result in the decrease in lattice energies and increased entropy.

Although DESs can offset the major drawbacks of conventional synthetic ILs, namely high toxicity, non-biodegradability, complex synthesis requiring purification, and high cost of the starting materials, NADESs can be even better candidates since their ingredients are derived from renewable sources. NADESs may be obtained by simply mixing two or three renewable, biodegradable and inexpensive natural components in a proper ratio under heating, such as, for example, amino acids, sugars, polyols, organic acids & bases, choline, betaine et al., which are capable of self-association through specific interactions to form a eutectic liquid mixture with a significantly lower melting temperature, usually below 100° C. Even though most NADESs can be made without water, water can be added in many cases to provide a wider range of applications. Moreover, other attractive physicochemical properties further facilitate their use in low-VOC waterborne coating manufacturing and application, such as, inter alia, low vapor pressure avoiding any atmospheric pollution and the corresponding hazards for worker exposure or derived risks, high plasticizing effect on film formation with improved thermal stability and reduced brittleness, solubilization of a number of organic compounds, stabilizing effect on natural pigments and colorants, water compatibility, and non-flammability.

Embodiments herein may provide DESs and NADESs, methods of their preparation, DES-based paint & coating products, and methods for using them.

In an embodiment, a composition may include a DES (including a NADES) system produced from quaternary ammonium and/or imidazolium salts and/or quaternary phosphonium salts and/or tertiary sulfonium salts, in which quaternary ammonium salts (such as Choline Chloride and Betaine), quaternary phosphonium salts (such as Allyltriphenylphosphonium Bromide), and hydrogen donors (such as Urea and D-Sorbitol) are combined in a suitable mole ratio under heating to form eutectic mixtures, which may then be used in combination with other ingredients for paint formulation under different orders of addition.

The incorporation of DES-based novel additives may extend the paint open time, co-dispersing and stabilizing pigments and colorants without negatively impacting paint stability, film properties and performances. In contrast to traditional low VOC open time additives, DES additives are effective at significantly lower levels (<0.1 wt. %), thus minimizing negative performance effects on the dried coating film, and can be derived from low cost, commodity materials.

Such embodiments may include quaternary ammonium and phosphonium salts with hydrogen-bond donors; DES-based low/zero VOC waterborne coating products and the processes of producing these materials, products, and the articles therefrom.

By extending open time and stabilizing pigments and colorants, DESs may improve the application feel, workability, and in-can stability of the paint in varied environments without compromising other paint properties and performance of the final film.

Components used to prepare DESs in embodiments may be identified and classified as not hazardous substances or mixtures by the Globally Harmonized System of Classification and Labelling of Chemicals (GHS). Embodiments may thus solve environmental issues carried by conventional solutions.

VOC regulations issued by the South Coast Air Quality Management District, the Environmental Protection Agency (EPA), California Air Resources Board (CARB), and Ozone Transport Commission (OTC), exempt low vapor pressure solvents in consumer products with a vapor pressure less than 0.1 mm Hg and a boiling point greater than 216° C. or 12 or more carbon atoms. The European Union (EU) and Canada exempt solvents with a boiling point greater than 250° C. Green Seal exempts solvents with a boiling point greater than 280° C. Therefore, selected NADESs with natural components having a boiling point greater than 280° C. may provide for ultra-low or zero VOC waterborne coatings with greener characters to meet certain biodegradable and recyclable needs and stringent regulations.

The presence of quaternary ammonium and/or imidazolium salts and/or quaternary phosphonium salts and/or tertiary sulfonium salts in the DES system may also have a synergistic effect when combined with other ingredients (e.g., a polymer binder, a surfactant, a defoamer, a thickener, a rheology modifier, a coalescent, and/or an organic colorant) that function as hydrogen-bond donors in the paint system, which may provide for water retention during drying due to the hydrogen bonding and charge delocalization between nonsymmetric ions and hydrogen-donor moieties. Those newly formed eutectic mixtures and DESs themselves may also serve as coalescing aids to improve the flexibility and processability of polymers by lowering the glass transition temperatures (T_{g}), thereby reducing the minimum film-formation temperature (MFFT) of the coating system. DESs may also serve as dispersants and/or wetting agents to better stabilize the pigments.

In addition, materials used to prepare embodiment DESs may be easily obtainable from many suppliers providing an advantage over specific commercial additives purchased from specialty chemical distributors, which may minimize the impact of raw material costs on margin by reducing supply chain costs, inventory, and cycle time, thereby enhancing the value chain.

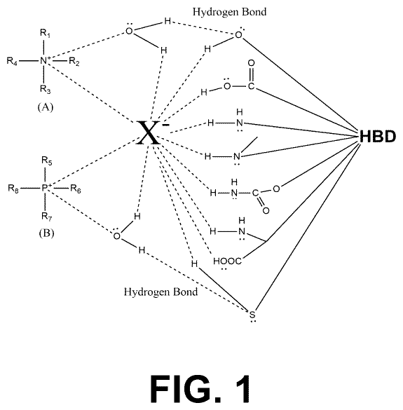

FIG. 1 illustrates postulated hydrogen bonds formed among a DES, hydrogen-bond donors and water in the paint system. Molecule (A) may represent a quaternary ammonium cation, that is, choline, betaine, and choline-like & betaine-like derivatives, such as, for example, betaine monohydrate, alanine, glycine, histidine, proline, or nicotinic acid. Molecule (B) may represent a quaternary phosphonium cation, that is, allyltriphenylphosphonium with its similar derivatives. R1, R2, R3, R5, R6, and R7 may include linear or branched chain alkyl, alkane, alkene, alkyne, cycloalkane and aromatic groups or mixtures of groups having 1-20 carbons, R4 and R8 may be selected from linear or branched chain alkyl, alkane, alkene, alkyne, cycloalkane and aromatic groups of 1-10 carbons attached with hydroxyl, carboxylic, ester linkages, silicon species, or similar Lewis base in X⁻. X⁻ may represent a Lewis base that is a halide anion (fluoride, chloride, bromide or iodide), citrate, bitartrate, carbonate, sulfate, methosulfate, saccharinate, nitrate, acetate, propionate, or benzoate. HBD may represent hydrogen-bond donors, including, for example, sugars, polyols, amino acids, organic acids, or any monomers, oligomers, and polymers with functional groups that contain —NH, —NH₂, —OH, or —SH bonds, such as hydroxyl, imine, amine, amide, or thiol, with varying electronegativities between those heteroatoms and H atom leading to highly polar covalent bonds. The R1-8, X′, and HBD moieties may be varied so as to provide the desired solvating properties, viscosity, melting point, and other properties, for the intended coating application.

Embodiments may include DESs and their use in compositions of architectural and industrial coatings, to methods of their preparation, and processes for using the same. Further embodiments may include preparation of NADESs and their use in compositions of paint formulation for various coating applications.

In one embodiment, the present invention describes a eutectic system that is made from a eutectic mixture of Lewis or Brønsted acids and bases which can contain a variety of anionic and/or cationic species. Deep eutectic solvents are typically obtained by mixing organic salts, such as quaternary ammonium and/or imidazolium salts and/or quaternary phosphonium salts and/or tertiary sulfonium salts, with a metal salt or HBD. The mixture forms a eutectic phase which has a lower melting point than the individual components because of the charge delocalization created through the hydrogen bonding. [symbol] The organic salt preferably includes a quaternary ammonium salt, such as, for example, choline chloride (ChCl), choline bitartrate, betaine (B), choline nitrate, choline acetate, N-ethyl-2-hydroxy-N,N-dimethylethanaminium chloride, N-benzyl-2-hydroxy-N,N-dimethylethanaminium chloride, 2-acetyloxy-N,N,N-trimethylethanaminium chloride, ethylammonium chloride, tetrapropylammonium bromide, tetrabutylammonium chloride, N,N-diethylethanolammonium chloride, N,N,N-trimethyl(phenyl)methanaminium chloride, N-benzyl-2-hydroxy-N-(2-hydroxyethyl)-N-methylethanaminium chloride, or 2-(acetyloxy)-N,N,N-trimethylethanaminium chloride; a quaternary imidazolium salt, such as, 1-butyl-3-methylimidazolium chloride, or 1-ethyl-3-butylbenzotriazolium hexafluorophosphate; a phosphonium salt, such as, for instance, allyltriphenylphosphonium bromide (ATPPB), methyltriphenylphosphonium bromide, or benzyltriphenylphosphonium chloride; or a tertiary sulfonium salt, such as dimethylsulfoniopropionate, S-methylmethionine, triphenylsulfonium triflate, or triphenylsulfonium nonaflate. A metal salt could be various metal halides, including FeCl₂, FeCl₃, AgCl, AlCl₃, CrCl₃, CuCl₂, LiCl, MgCl₂, ZnCl₂, ZnBr₂, SnCl₂, or SnCl₄. The HBD may comprise, for example, urea (U), acetamide, 1-methyl urea, N-methylacetamide, 1,3-dimethyl urea, 1,1-dimethyl urea, 1-(trifluoromethyl) urea, thiourea, benzamide, imidazole, 2,2,2-trifluoroacetamide, glycerol, hexanediol, ethylene glycol, 1,2-propanediol, 2,3-butanediol, 1,4-butanediol, hexanediol, diethylene glycol, triethylene glycol, adipic acid, citric acid, malonic acid, malic acid, oxalic acid, oxalic acid dihydrate, glutaric acid, glycolic acid, levulinic acid, lactic acid, itaconic acid, L-(+)-tartaric acid, succinic acid, tricarballylic acid, phenylpropionic acid, phenyl acetic acid, phenol, o-cresol, xylenol, or sugars, such as D-sorbitol(S), xylitol, D-fructose, D-glucose, or D-isosorbide. Depending on the composition, the melting point of the mixtures may be considerably lower than the melting point of either component, which can be 132-135° C. for urea, 98-100° C. for D-sorbitol, 301° C. for betaine, 302-305° C. for choline chloride, and 222-225° C. for allyltriphenylphosphonium bromide. DESs may be prepared in a proper ratio under heating (50-200° C.) at atmospheric pressure for the mixtures shown in Table I, in which B-U, B-S, ChCl-U and ChCl-S can be classified as NADESs due to their natural ingredients. Table I may describe DESs formed between quaternary ammonium and phosphonium salts and hydrogen bond donors.

TABLE I
Ammonium

| | Quaternary Ammonium and | Hydrogen Bond | Mole |
|---|---|---|---|
| Code | Phosphonium Salt | Donor | Ratio |
| B-U | Betaine | Urea | 2:3 |
| B-S | Betaine | D-Sorbitol | 1:1 |
| ChCl-U | Choline Chloride | Urea | 1:2 |
| ChCl-S | Choline Chloride | D-Sorbitol | 1:1 |
| ATPPB- | Allyltriphenylphosphonium | D-Sorbitol | 1:8 |
| S8 | Bromide | | |
| ATPPB- | Allyltriphenylphosphonium | D-Sorbitol | 1:12 |
| S12 | Bromide | | |

Another embodiment may include a high-quality paint composition with DES additives yielding an extended open time. Conventional compositions of architectural paints contain one or more pigments, one or more binders, a liquid carrier (e.g., water), and one or more additives that include, for example, leveling agents, neutralizing agents, rheology modifiers, surfactants, corrosion inhibitors, open-time improvers, and biocides et al. DESs listed in Table I, in addition to benchmarking products (e.g., SOLVAY RHODOLINE® OTE 600 or LUBRIZOL HUMECTANT GRB4), may be added to water-based zero-VOC acrylic semi-gloss paint (Control 01) with liquid properties and optical properties of the final dry films as summarized in Table II. Moreover, selected NADESs with SOLVAY RHODOLINE® OTE 600 may be added into an experimental 50 g/L water-based acrylic semi-gloss formulation (Control 02) to further evaluate influence on the properties of both liquid paints and dry films as shown in Table III. Experimentation has demonstrated that the DES embodiments outperform the commercially available additives with improved open time and without significantly impacting paint stability and film properties.

Table II may depict property changes from liquid paints with their dry films on LENETA paint test charts before and after adding DESs and benchmarking products. For the open time property, an average value of three replicates based on ASTM D7488-10 with tested paints was applied to a LENETA chart using a 7 mil (177.8 microns) DOW drawdown bar at 25±2° C., 30±5% RH. “PPH” may refer to pounds per 100 gallons (e.g., 2 pph≈0.2 wt. %). Early water resistance blistering may reference ASTM D714 with a standardizing rating scale 1 to 10 representing poor to excellent. Surfactant leaching may refer to ASTM D7190 with a standardizing rating scale 1 to 5 representing severe to none.

TABLE II

| | | | | | | | | | Prototype 7 | Prototype 8 |
|---|---|---|---|---|---|---|---|---|---|---|
| | | | | | | | Prototype 5 | Prototype 6 | Post-added | Post-added |
| | | | Prototype 1 | Prototype 2 | Prototype 3 | Prototype 4 | Post-added | Post-added | 2 pph of | 2 pph of |
| | | Control | Post-added | Post-added | Post-added | Post-added | 2 pph of | 2 pph of | SOLVAY | LUBRIZOL |
| | | 01 | 2 pph of | 2 pph of | 2 pph of | 2 pph of | ATPPB- | ATPPB- | RHODOLINE | HUMECTANT |
| | | DE | B-U into | B-S into | ChCl-U into | ChCl-S into | S8 into | S12 into | OTE 600 into | GRB4 into |
| Code/Properties | | Paint | control 01 | control 01 | control 01 | control 01 | control 01 | control 01 | control 01 | control 01 |
| Equilibrated | | 103.3 | 103.7 | 104 | 103.8 | 103.9 | 103.1 | 102.6 | 100.4 | 102.2 |
| KU | | | | | | | | | | |
| Equilibrated | | 1.546 | 1.575 | 1.617 | 1.564 | 1.617 | 1.429 | 1.282 | 1.25 | 1.287 |
| ICI | | | | | | | | | | |
| Equilibrated | | 8.93 | 8.87 | 8.86 | 8.87 | 8.87 | 8.88 | 8.88 | 8.96 | 8.94 |
| pH | | | | | | | | | | |
| 1 week | | 97.46 | 97.35 | 97.66 | 97.63 | 97.91 | 98.6 | 98.79 | 98.29 | 98.46 |
| Contrast | | | | | | | | | | |
| Ratio (%) | | | | | | | | | | |
| 1 week | | 92.53 | 92.8 | 93.12 | 93.21 | 93.17 | 93.02 | 92.61 | 92.49 | 92.76 |
| Reflectance | | | | | | | | | | |
| (%) | | | | | | | | | | |
| 1 week | | 1.38 | 1.57 | 1.59 | 1.69 | 1.90 | 1.54 | 1.36 | 1.41 | 1.46 |
| Yellowness | | | | | | | | | | |
| Index | | | | | | | | | | |
| 1 week Gloss | | 12.5 | 12 | 12.5 | 12 | 12.5 | 13 | 13.2 | 13.9 | 13.1 |
| @ 20° | | | | | | | | | | |
| 1 week Gloss | | 48.7 | 48.5 | 48.5 | 48.3 | 49.7 | 48.9 | 50 | 49.7 | 48.7 |
| @ 60° | | | | | | | | | | |
| 1 week Gloss | | 82.6 | 86.5 | 86.3 | 85.4 | 84 | 82.9 | 83.7 | 80.7 | 80 |
| @ 85° | | | | | | | | | | |
| Leveling | | 7 | 7 | 8 | 7 | 6 | 8 | 8 | 9 | 7 |
| Sag | | 18 | 18 | 16 | 16 | 18 | 18 | 16 | 18 | 16 |
| resistance | | | | | | | | | | |
| Open time | | 5 | 8 | 8 | 8 | 8 | 8 | 8 | 5 | 6 |
| (min) | | | (+60%) | (+60%) | (+60%) | (+60%) | (+60%) | (+60%) | | (+20%) |
| Pendulum | 1 week | 8 | 7 | 7 | 7 | 7 | 7 | 7 | 7 | 7 |
| Hardness | | | (−12.5%) | (−12.5%) | (−12.5%) | (−12.5%) | (−12.5%) | (−12.5%) | (−12.5%) | (−12.5%) |
| (Count) | 2 week | 8 | 8 | 8 | 7 | 8 | 8 | 8 | 8 | 7 |
| | | | | | (−12.5%) | | | | | (−12.5%) |
| | 4 week | 8 | 7 | 7 | 7 | 7 | 8 | 8 | 8 | 7 |
| | | | (−12.5%) | (−12.5%) | (−12.5%) | (−12.5%) | | | | (−12.5%) |
| Early | 2 h | 10 | 10 | 10 | 10 | 10 | 10 | 10 | 10 | 10 |
| Water | 4 h | 10 | 10 | 10 | 10 | 10 | 10 | 10 | 10 | 10 |
| Resistance | 1 day | 10 | 10 | 10 | 10 | 10 | 10 | 10 | 10 | 10 |
| Blistering | 7 day | 10 | 10 | 10 | 10 | 10 | 10 | 10 | 10 | 10 |
| Surfactant | 4 h | 4 | 3 | 3 | 4 | 3 | 3 | 3 | 3 | 3 |
| Leaching | 1 day | 4 | 3 | 3 | 4 | 3 | 4 | 4 | 3 | 4 |
| | 3 day | 4 | 4 | 3 | 4 | 4 | 3 | 3 | 3 | 3 |
| | 7 day | 4 | 4 | 3 | 4 | 4 | 3 | 3 | 3 | 4 |

Table III depicts liquid paint properties and optical properties of final dry films before and after adding selected NADESs and benchmarking products into experimental paint (Control 02). The open time may represent an average value of three replicates based on ASTM D7488-10 with tested paints applied to a LENETA chart using a 7 mil (177.8 microns) DOW drawdown bar at 25±2° C., 30±5% RH.

TABLE III

| | | | | | | | Prototype 11 | |
|---|---|---|---|---|---|---|---|---|
| | | | Prototype 9 | | Prototype 10 | | Post-added | |
| | | Control 02 | Post-added | | Post-added | | 2 pph of | |
| | | DE | 2 pph of | | 2 pph of | | Solvay OTE | |
| | | Experimental | ChCl-U into | | B-S into | | 600 into | |
| Code/Properties | | Paint | control 02 | | control 02 | | control 02 | |
| Equilibrated KU | | 108.2 | 108.6 | | 106.5 | | 103.3 | |
| Equilibrated ICI | | 1.375 | 1.375 | | 1.374 | | 1.375 | |
| Equilibrated pH | | 8.76 | 8.7 | | 8.73 | | 8.71 | |
| 1 week Contrast Ratio (%) | | 98.12 | 98 | | 98.34 | | 97.85 | |
| 1 week Reflectance (%) | | 92.5 | 93.04 | | 93.3 | | 93.02 | |
| 1 week Yellowness Index | | 1.25 | 1.36 | | 1.48 | | 1.35 | |
| 1 week Gloss @ 20° | | 9.8 | 10 | | 10 | | 9.8 | |
| 1week Gloss @ 60° | | 45.3 | 45.4 | | 45.7 | | 45.1 | |
| 1 week Gloss @ 85° | | 78.3 | 77.9 | | 79.3 | | 78.8 | |
| Leveling | | 9 | 9 | | 9 | | 9 | |
| Sag resistance | | 12 | 12 | | 12 | | 12 | |
| Open time (min) | | 8 | 12 | (+50%) | 14 | (+75%) | 10 | (+25%) |
| Pendulum | 3 day | 45 | 43 | (−4.4%) | 42 | (−6.7%) | 42 | (−6.7%) |
| Hardness | 1 week | 49 | 46 | (−6.1%) | 48 | (−2.0%) | 48 | (−2.0%) |
| (Count) | 2 week | 54 | 52 | (−3.7%) | 51 | (−5.5%) | 50 | (−7.4%) |
| | 4 week | 56 | 53 | (−5.4%) | 54 | (−3.6%) | 53 | (−5.4%) |

Another embodiment may include pseudo-DESs and their roles in the paint formulating and application. Pseudo-DESs may include blends of those ingredients listed in Table I under same mole ratios without forming eutectic mixtures. Table IV summarizes the effect of those pseudo-DESs plus their single ingredients on the property changes of liquid paints and dry films. Compared to results in Table II, authentic DESs may exhibit superior performance to pseudo-DESs and benchmarking products in terms of open time extending, dry film smoothness and water sensitivity.

Table IV may illustrate property changes from liquid paints with their dry films before and after adding selected pseudo-DESs with their single ingredients. The open time may represent an average value of three replicates based on ASTM D7488-10 with tested paints applied to a LENETA chart using a 7 mil (177.8 microns) DOW drawdown bar at 25±2° C., 30±5% RH. Early water resistance blistering may reference ASTM D714 with a standardizing rating scale 1 to 10 representing poor to excellent. Surfactant leaching may refer to ASTM D7190 with a standardizing rating scale 1 to 5 representing severe to none.

TABLE IV

| | | | Prototype 12 | Prototype 13 | Prototype 14 | Prototype 15 | Prototype 16 | Prototype 17 | Prototype 18 | Prototype 19 |
|---|---|---|---|---|---|---|---|---|---|---|
| | | Control | Post-added | Post-added | Post-added | Post-added | Post-added | Post-added | Post-added | Post-added |
| | | 01 | 2 pph of | 2 pph of | 2 pph of | 2 pph of | 2 pph of | 2 pph of | 2 pph of | 2 pph of |
| | | DE | B into | B & U into | B & S into | ChCl into | ChCl & U into | ChCl & S into | S into | ATPPB into |
| Code/Properties | | Paint | control 1 | control 01 | control 01 | control 01 | control 01 | control 01 | control 01 | control 01 |
| Equilibrated | | 103.3 | 100.3 | 99.8 | 100 | 99.6 | 99.4 | 99.7 | 100.3 | 101.4 |
| KU | | | | | | | | | | |
| Equilibrated | | 1.546 | 1.66 | 1.6 | 1.645 | 1.587 | 1.575 | 1.685 | 1.625 | 1.262 |
| ICI | | | | | | | | | | |
| Equilibrated | | 8.93 | 8.81 | 8.82 | 8.8 | 8.81 | 8.81 | 8.81 | 8.8 | 8.86 |
| pH | | | | | | | | | | |
| 1 week | | 97.46 | 96.71 | 97.29 | 97.33 | 97.3 | 97.78 | 97.42 | 98.1 | 98.04 |
| Contrast | | | | | | | | | | |
| (%) | | | | | | | | | | |
| 1 week | | 92.53 | 97.73 | 92.76 | 92.94 | 93.02 | 93 | 93.14 | 92.93 | 92.77 |
| Reflectance | | | | | | | | | | |
| (%) | | | | | | | | | | |
| 1 week | | 1.38 | 1.44 | 1.66 | 1.59 | 1.75 | 1.86 | 1.79 | 1.68 | 1.62 |
| Yellowness | | | | | | | | | | |
| Index | | | | | | | | | | |
| 1 week Gloss | | 12.5 | 12.8 | 13.3 | 13 | 12.6 | 12.7 | 12.7 | 12.9 | 12.1 |
| @ 20° | | | | | | | | | | |
| 1 week Gloss | | 48.7 | 48.9 | 49.5 | 49.5 | 48.5 | 48.9 | 48.8 | 48.2 | 48 |
| @ 60° | | | | | | | | | | |
| 1 week Gloss | | 82.6 | 84.8 | 84.9 | 85.1 | 83.3 | 84.2 | 83.8 | 84.2 | 82.9 |
| @ 85° | | | | | | | | | | |
| Leveling | | 7 | 7 | 7 | 7 | 8 | 7 | 8 | 7 | 8 |
| Sag | | 18 | 18 | 18 | 16 | 16 | 20 | 16 | 18 | 18 |
| resistance | | | | | | | | | | |
| Open time | | 5 | 6 | 5 | 8 | 6 | 7 | 7 | 5 | 5 |
| (min) | | | (+20%) | | (+60%) | (+20%) | (+40%) | (+40%) | | |
| Pendulum | 1 week | 8 | 7 | 6 | 6 | 7 | 6 | 7 | 7 | 8 |
| Hardness | | | (−12.5%) | (−25%) | (−25%) | (−12.5%) | (−25%) | (−12.5%) | (−12.5%) | |
| (Count) | 2 week | 8 | 7 | 7 | 7 | 7 | 6 | 7 | 7 | 7.5 |
| | | | (−12.5%) | (−12.5%) | (−12.5%) | (−12.5%) | (−25%) | (−12.5%) | (−12.5%) | (−6.25%) |
| | 4 week | 8 | 7 | 6 | 6 | 7 | 7 | 7 | 7 | 7.5 |
| | | | (−12.5%) | (−25%) | (−25%) | (−12.5%) | (−12.5%) | (−12.5%) | (−12.5%) | (−6.25%) |
| Early | 2 h | 10 | 10 | 10 | 10 | 10 | 10 | 10 | 10 | 10 |
| Water | 4 h | 10 | 10 | 10 | 10 | 10 | 10 | 10 | 10 | 10 |
| Resistance | 1 day | 10 | 10 | 10 | 10 | 10 | 10 | 10 | 10 | 10 |
| Blistering | 7 day | 10 | 10 | 10 | 10 | 10 | 10 | 10 | 10 | 10 |
| Surfactant | 4 h | 4 | 3 | 4 | 3 | 4 | 4 | 3 | 3 | 3 |
| Leaching | 1 day | 4 | 3 | 3 | 3 | 4 | 4 | 3 | 3 | 4 |
| | 3 day | 4 | 3 | 3 | 3 | 4 | 3 | 3 | 3 | 3 |
| | 7 day | 4 | 3 | 3 | 3 | 3 | 3 | 3 | 3 | 4 |

In testing, to support improved open time claims on a practical application basis, two sets of samples were brush applied on primed six-panel wood doors. Six-panel doors are usually painted by brush so that the finish is as smooth as possible when spray application cannot be performed. For these evaluations, applications were conducted by an applications specialist in accordance with ASTM Practice D3925, under conditions in accordance with the Conditioning and Testing section of ASTM Specification D3924. The first set of samples contained post-addition of authentic DESs, LUBRIZOL's HUMECTANT GRB4 and SOLVAY's open time enhancer labelled RHODOLINE OTE 600, to a water-based zero-VOC acrylic semi-gloss paint (Control 01) with liquid properties and optical properties of the final dry films as previously summarized in Table II. The second set of samples contained post-addition of authentic DES inventions and RHODOLINE OTE 600 to an experimental 50 g/L water-based acrylic semi-gloss formulation (Control 02). The primer used in both applications was a water-based acrylic multi-purpose primer.

The test paint was applied by a 6½″⅜″ woven mini roller cover on the raised panels and coves between the raised portions and stiles or rails of each panel, and then finished with a 2.5″ sash brush over the entire surface of the door. This combined roller and brush application technique is performed in the field so that paint is applied faster to minimize blemishes such as flashing or heavy brush markings due to poor open time of low and zero-VOC products. The top half of the door was painted first, and the bottom half was painted last; both halves have final horizontal brush strokes across the rails and are finished with vertical brush strokes along the outside frame on the hinge and latch stiles. Open time was evaluated along the cross rail near the top of the door and along the lock rail and its intersection with the hinge and latch stiles near the middle of the door.

Various observations were made during and after the application for certain properties and rated on a scale from 1-10 for both wet and dry performance, with 10 being the highest performing score (Table V). In the first application, the betaine-sorbitol combination (authentic NADES: B-S) was equal in performance to RHODOLINE OTE 600 and better than Control 01 with no additives. For the second application, the choline chloride-urea combination (authentic NADES: ChCl-U) provided the best brush application as compared to Control 02 and all prototypes evaluated in the set. Overall, the wet rating observation data demonstrate the DES applications improve open time and brush workability so that the dry film appearance is improved and are comparable or outperform the commercially available additives tested.

Table V-A and Table V-B depict certain properties rating on a scale of 1-10 for the six-panel door application of two different experiments. Table V-A depicts results from use of a water-based zero-VOC acrylic semi-gloss paint (Control 01).

TABLE V-A

| | | | Prototype 3 | Prototype 2 | Prototype 7 | Prototype 7-2 | Prototype 8 | Prototype 8-2 |
|---|---|---|---|---|---|---|---|---|
| | | | Post-added | Post-added | Post-added | Post-added | Post-added | Post-added |
| | | | 2 pph of | 2 pph of | 2 pph of | 10 pph of | 2 pph of | 10 pph of |
| | | Control 01 | ChCl-U into | B-S into | OTE 600 into | OTE 600 into | GRB4 into | GRB4 into |
| Code/Performance | | DE Paint | Control 01 | Control 01 | Control 01 | Control 01 | Control 01 | Control 01 |
| Wet | Brush Drag Wet | 10 | 10 | 10 | 10 | 8 | 8 | 8 |
| | Brush | 10 | 10 | 10 | 10 | 2 | 2 | 2 |
| | Foam/Pinholing | 8 | 8 | 10 | 10 | 8 | 8 | 8 |
| | Brush | | | | | | | |
| | Streaking/Cissing | | | | | | | |
| | Brush Sagging | 10 | 10 | 10 | 10 | 10 | 10 | 10 |
| | Brush Open | 10 | 10 | 10 | 10 | 6 | 6 | 8 |
| | Time/Workability | | | | | | | |
| | Average Wet | 9.6 | 9.6 | 10.0 | 10.0 | 6.8 | 6.8 | 7.2 |
| | Observation Score | | | | | | | |
| Dry | Brush | 10 | 10 | 10 | 10 | 10 | 10 | 10 |
| Ratings | Foam/Pinholing | | | | | | | |
| | Brush Marks - Flow | 6 | 8 | 6 | 6 | 6 | 6 | 4 |
| | & Leveling | | | | | | | |
| | Brush Streaking | 6 | 4 | 8 | 8 | 6 | 4 | 6 |
| | Brush Sag | 10 | 10 | 10 | 10 | 10 | 10 | 10 |
| | Resistance | | | | | | | |
| | Average Dry | 8.0 | 8.0 | 8.5 | 8.5 | 8.0 | 7.5 | 7.5 |
| | Observation Score | | | | | | | |

| | | | | | | | |
|---|---|---|---|---|---|---|---|
| Overall Average | 8.9 | 8.9 | 9.3 | 9.3 | 7.3 | 7.1 | 7.3 |
| Observation Score | | | | | | | |

Table V-B depicts results from use of an experimental 50 g/L water-based acrylic semi-gloss formulation (Control 02).

TABLE V-B

| | | | Prototype 9 | Prototype 10 | Prototype 11 |
|---|---|---|---|---|---|
| | | Control 02 | Post-added | Post-added | Post-added |
| | | DE | 2 pph of | 2 pph of | 2 pph of |
| | | Experimental | ChCl-U into | B-S into | OTE600 into |
| Code/Performance | | Paint | Control 02 | Control 02 | Control 02 |
| Wet | Brush Drag | 4 | 8 | 6 | 6 |
| Ratings | Brush Foam/Pinholing | 10 | 10 | 10 | 10 |
| | Brush Streaking/Cissing | 6 | 8 | 6 | 6 |
| | Brush Sagging | 8 | 8 | 8 | 8 |
| | Brush Open | 2 | 8 | 4 | 6 |
| | Time/Workability | | | | |
| | Average Wet | 6.0 | 8.4 | 6.8 | 7.2 |
| | Observation Score | | | | |
| Dry | Brush Foam/Pinholing | 10 | 10 | 10 | 10 |
| Ratings | Brush Marks - Flow & | 4 | 8 | 6 | 6 |
| | Leveling | | | | |
| | Brush Streaking | 8 | 8 | 8 | 8 |
| | Brush Sag Resistance | 10 | 10 | 10 | 10 |
| | Average Dry | 8.0 | 9.0 | 8.5 | 8.5 |
| | Observation Score | | | | |

| | | | | |
|---|---|---|---|---|
| Overall Average Observation | 6.9 | 8.7 | 7.6 | 7.8 |
| Score | | | | |

NADESs and benchmarking products at higher level of addition (10 pph≈1.0 wt. %) were also added into a revised experimental 50 g/L waterborne acrylic semi-gloss formulation (Control 02-2) to evaluate their effects on the properties of liquid paints and dry films as summarized in Table VI. Selected DESs, such as B-S and ChCl-U, provided an equal performance in terms of open time extension to those commercial additives which mostly mimic polyglycols or polyglycerols with ether and alcohol groups (e.g., PEG 400) causing a significant decrease in KU followed by a sagging issue and incompatibility issues such as grits and foam found on their wet and dry films.

Table VI depicts liquid paint properties and optical properties of the final dry films before and after adding selected NADESs and benchmarking products into experimental paint (Control 02-2). The open time may represent average values of three replicates based on ASTM D7488-10 with tested paints applied to a LENETA chart using a 7 mil (177.8 microns) DOW drawdown bar at 25±2° C., 30±5% RH.

TABLE VI

| | | Prototype 20 | | | | |
|---|---|---|---|---|---|---|
| | | In-process | | | | |
| | | added | Prototype 21 | | | |
| | | 10 pph of | Post-added | Prototype 22 | Prototype 23 | Prototype 24 |
| | Control 02-2 | SOLVAY | 10 pph of | Post-added | Post-added | Post-added |
| | DE | RHODOLINE ® | PAT-ADD | 10 pph of | 10 pph of | 10 pph of |
| Code/ | Experimental | OTE 600 into | OT2034 into | ChCl-U into | B-S into | ChCl-S into |
| Properties | Paint | control 02-2 | control 02-2 | control 02-2 | control 02-2 | control 02-2 |
| Open time | 12 | 20 | 22 | 20 | 22 | 18 |
| (min) | | (+67%) | (+83%) | (+67%) | (+83%) | (+50%) |
| Equilibrated | 100.3 | 88.8 | 89 | 103.6 | 97.3 | 103.4 |
| KU | | | | | | |
| Equilibrated | 1.200 | 1.175 | 1.025 | 1.183 | 1.15 | 1.203 |
| ICI | | | | | | |
| Equilibrated | 8.64 | 8.57 | 8.48 | 8.5 | 8.54 | 8.52 |
| pH | | | | | | |
| 1 week | 97.62 | 97.91 | 98.14 | 98.22 | 97.69 | 98.01 |
| Contrast | | | | | | |
| Ratio (%) | | | | | | |
| 1 week | 92.7 | 92.22 | 92.51 | 92.99 | 92.55 | 92.9 |
| Reflectance | | | | | | |
| (%) | | | | | | |
| 1 week | 1.53 | 1.41 | 1.61 | 1.73 | 1.56 | 1.74 |
| Yellowness | | | | | | |
| Index | | | | | | |
| 1 week | 8.6 | 7.7 | 8.6 | 8.9 | 9.2 | 9.3 |
| Gloss @ | | | | | | |
| 20° | | | | | | |
| 1 week | 42.2 | 40 | 41.8 | 42.5 | 43.2 | 43.5 |
| Gloss @ | | | | | | |
| 60° | | | | | | |
| 1 week | 71.4 | 71.1 | 71.5 | 71.6 | 71.9 | 72 |
| Gloss @ | | | | | | |
| 85° | | | | | | |
| Film | Smooth | Sagging | Grits | Smooth | Smooth | Smooth |
| Appearance | | issue | and | | | |
| on a 3 mil | | found | foam | | | |
| drawdown | | | found | | | |

Further measurement was performed by FORMULACTION using the RHEOLASER COATING ANALYZER. The open time test was conducted in a constant temperature and humidity area (23° C., ˜25% RH), with results shown in Table VII. The tested paints were applied to an area of ˜900 mm² at a distance of 16 cm with a wet film thickness of 250 microns. Compared to 10 pph of OTE 600 giving three and a half minutes extension of open time, ChCl-U and B-S at a half level (5 pph≈0.5 wt. %) result in an increase of around two minutes and one and a half minutes at 23° C., respectively. Moreover, in-process added OTE600 as advised negatively affects the paint rheology with significant drop in KU and ICI and does not provide compatibility with low and zero-VOC latex paints with grits found on its 3 mil drawdown. However, the present invention with DESs overcomes the aforementioned limitations of conventional applications.

Table VII depicts open time evaluation with RHEOLASER COATING ANALYZER. The open time may represent average values of two replicates.

TABLE VII

| | | Sample A | | |
|---|---|---|---|---|
| | | In-process | | |
| | | added 10 pph | Sample B | Sample C |
| | | of SOLVAY | Post-added | Post-added |
| | | RHODOLINE ® | 5 pph of | 5 pph of |
| | Control 01 | OTE 600 into | ChCl-U into | B-S into |
| Code/Properties | DE Paint | control 01 | control 01 | control 01 |
| Open time | 33′06″ | 36′46″ | 35′08″ | 34′34″ |
| Equilibrated KU | 103.3 | 93.7 | 102.1 | 102.9 |
| Equilibrated ICI | 1.546 | 0.817 | 1.275 | 1.317 |
| Equilibrated pH | 8.93 | 9.03 | 8.81 | 8.85 |
| 1 week Contrast | 97.46 | 98.53 | 98.63 | 98.17 |
| Ratio (%) | | | | |
| 1 week Reflectance | 92.53 | 92.1 | 93 | 93.14 |
| (%) | | | | |
| 1 week Yellowness | 1.38 | 1.55 | 1.68 | 1.75 |
| Index | | | | |
| 1 week Gloss @ 20° | 12.5 | 11.2 | 14 | 14.5 |
| 1 week Gloss @ 60° | 48.7 | 47.2 | 49.7 | 49.9 |
| 1 week Gloss @ 85° | 82.6 | 80.3 | 80.9 | 80.8 |
| Film Appearance on | Smooth | Grits found | Smooth | Smooth |
| a 3 mil drawdown | | | | |

A rheological study was also conducted by incorporating DESs and RHODOLINE® OTE600 at the same level of 10 pph (˜1.0 wt. %) into water-based zero-VOC acrylic semi-gloss paint (Control 01) and analyzed with ANTON PAAR MCR Rheometer MCR301.

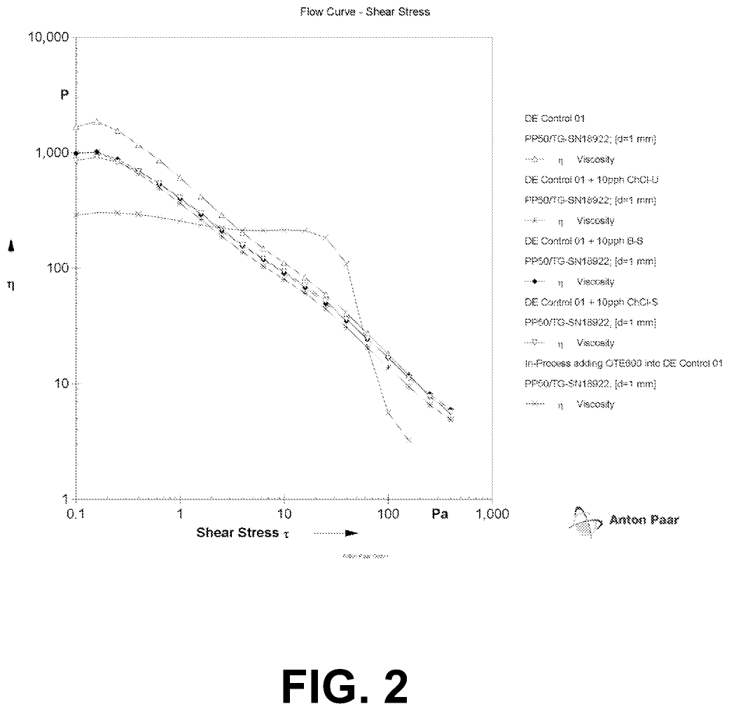

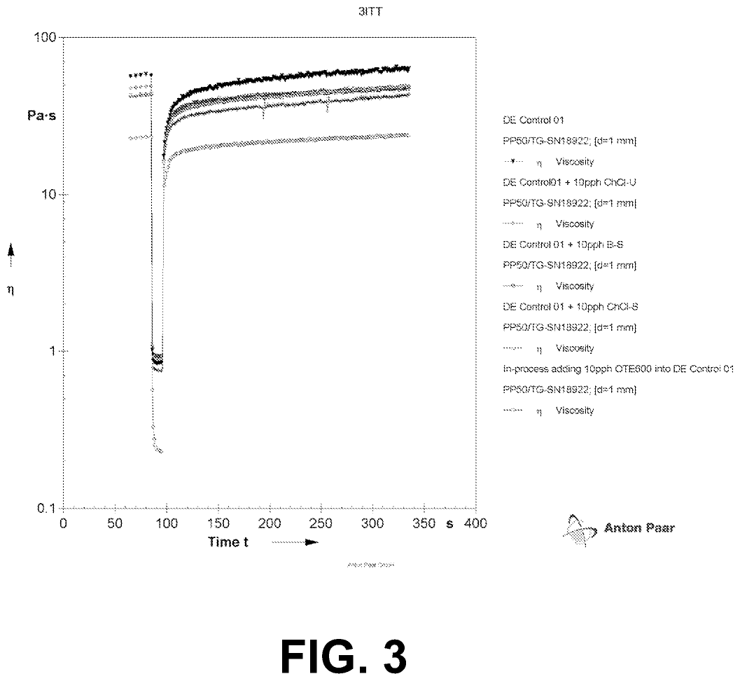

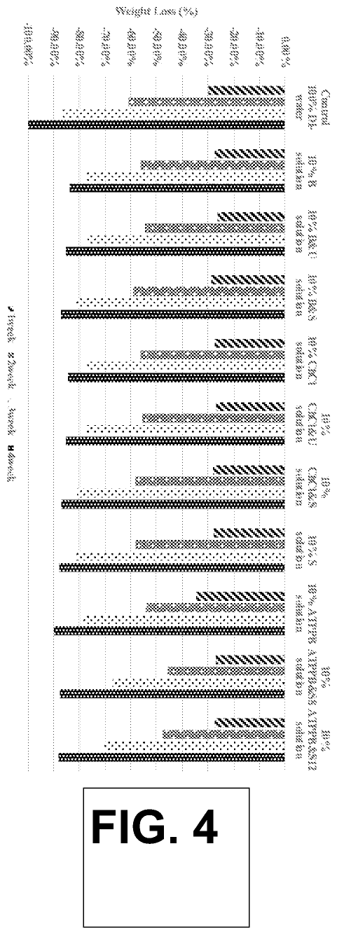

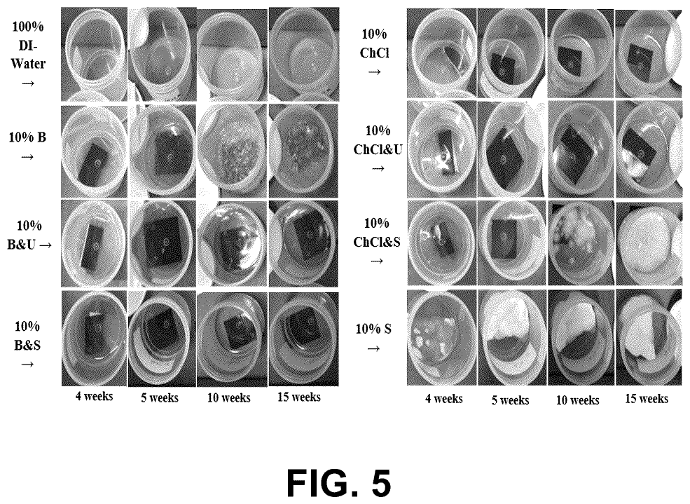

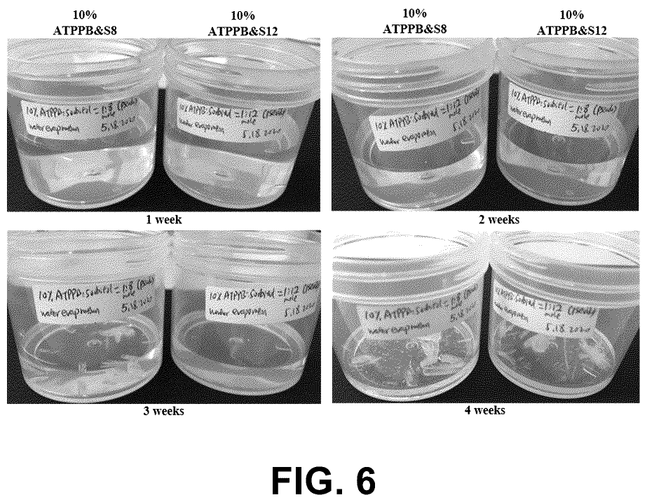

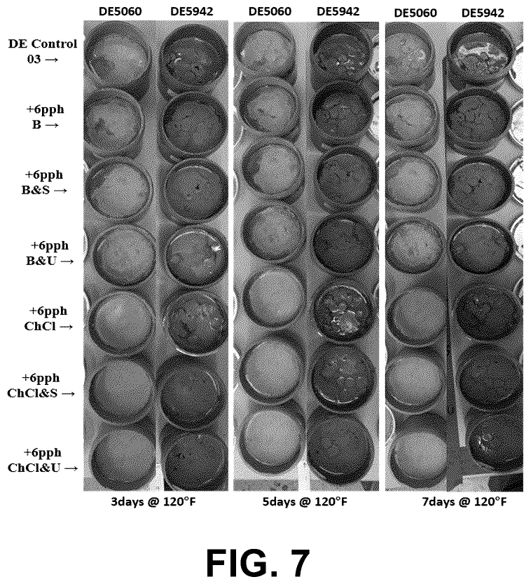

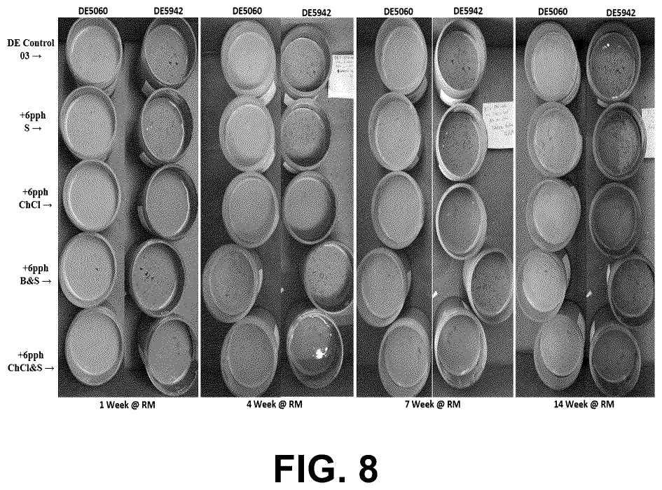

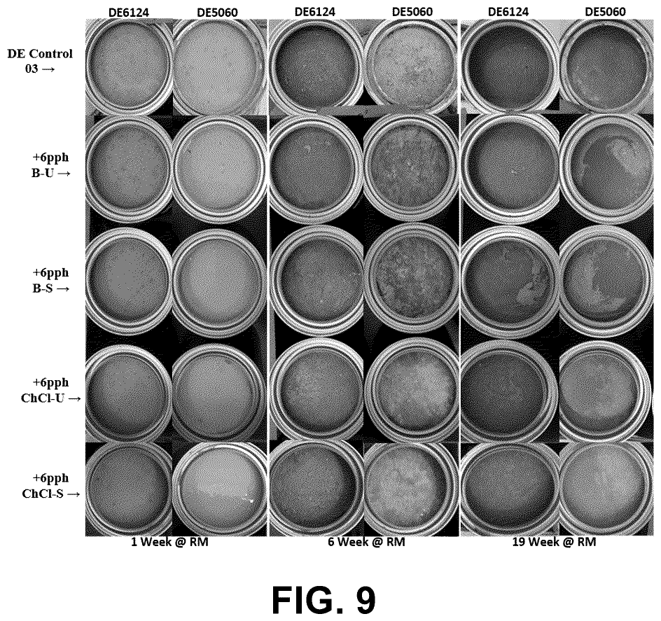

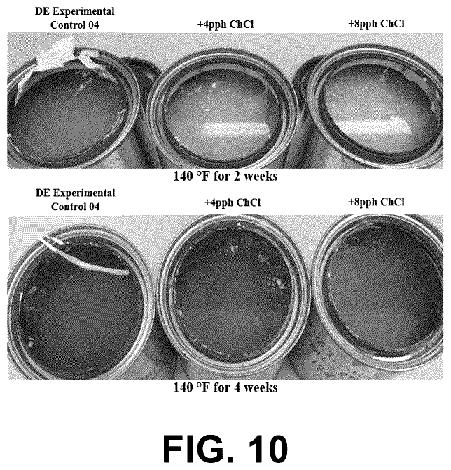

FIG. 2 illustrates viscosity curves of different open-time additives in paint Control 01. In particular, FIG. 2 illustrates typical measuring viscosity curves calculated by the software from the flow curve data and represents the shear viscosity (n) over the shear stress (T), in which OTE 600 radically changes the flow behavior compared to Control 01 and other DES incorporated samples. Relatively lower viscosities resulted from OTE600 at both low and high shear stress indicate KU and ICI drop as observed in Table VII, and possible sagging problems in a high-speed coating application.

FIG. 3 illustrates a three-interval thixotropy test (3ITT) on open-time additives in paint Control 01. In particular, FIG. 3 shows thixotropic behavior using 3ITT with three measuring periods that simulate the behavior of paints at rest, their behavior during application, and their structural recovery after application. The time course of the viscosity is measured during application and then during structural recovery of the samples. Table VIII summarizes the recovery time needed to recover their original structures, in which the ChCl-S added sample is heaviest delayed compared to other additives followed by the ChCl-U, the 2^{nd} candidate rebuilding its structure at a slower pace. Control 01 plus DES incorporated samples with relatively high viscosities at rest (or at low stresses) usually slow down effects like phase separation and sedimentation and therefore improve the shelf life of the formulation. A heavier delayed recovery resulted from ChCl-S and ChCl-U could also improve the leveling behavior of the coatings, avoid the brush or roller marks, and thereby allow for the formation of an even surface, which may further explain their stronger open-time improving capability to slow down the drying process of the aqueous paints and allow subsequently applied paint to blend with a freshly applied one without the appearance of lack of uniformity.

TABLE VIII

| | Time needed to |
|---|---|
| | completely |
| | regain original |
| Code/Properties | structure |
| DE Control 01 | 138 seconds |
| Post-added 10 pph of | 229 Seconds |
| ChCl-U into control 01 | (+66%) |
| Post-added 10 pph of B-S | 105 Seconds |
| into control 01 | (−24%) |
| Post-added 10 pph of | 234 Seconds |
| ChCl-S into control 01 | (+70%) |
| In-process added 10 pph | 187 Seconds |
| of SOLVAY RHODOLINE ® | (+35.5%) |
| OTE 600 into control 01 | |

Further experimentation illustrates the hygroscopicity of the ingredients listed in Table I. This investigation included preparing 10% of solutions with deionized water followed by exposing them in a conditional room at atmospheric pressure under temperature 20-25° C. and relative humidity 40-46% with data shown in FIG. 4 and pictures shown in FIGS. 5 and 6. Among those pseudo-DESs and their ingredients, B&U (mole ratio 2:3), B&S (mole ratio 1:1), ChCl&U (mole ratio 1:2) and choline chloride itself exhibit relative better capability of water retention than the others to continually maintain the liquid state over time, indicating the relatively higher tendency of those paired ingredients to water absorption (i.e. hygroscopic nature) when being exposed in open air, and thereby forming unique eutectic systems to extend the paint open time during drying. It could be attributed to their unique hydrogen-bonding networks formed with a water molecule that can also be taken as a hydrogen-bonding donor.

FIG. 4 illustrates measurement of the weight loss by water evaporation over a 4-week period.

FIG. 5 illustrates a water evaporation test of quaternary ammonium based pseudo-DESs with their single ingredients at atmospheric pressure under temperature 20-25° C. and relative humidity 40-46%.

FIG. 6 illustrates a water evaporation test of quaternary phosphonium based pseudo-DESs at atmospheric pressure under temperature 20-25° C. and relative humidity 40-46%.

Further experimentation illustrates the VOC contribution of DES. VOC levels are generally defined by the (EPA). Low-VOC compositions and components can have a VOC content of not more than about 250 g/L (about 25% w/v), preferably not more than about 50 g/L (about 5% w/v). Zero-VOC compositions can also be part of the low-VOC embodiments herein. Zero-VOC compositions can advantageously have a VOC content of not more than about 10 g/L (about 1% w/v), preferably not more than about 5 g/L (about 0.5% w/v). The major sources of VOCs in architectural coatings are the open time/freeze-thaw additives and some coalescents. Embodiments herein with both DESs and pseudo-DESs, along with their single ingredients having boiling point higher than 280° C., may exhibit improvements over conventional art since the paint extenders developed herein can be added to aqueous paints to prolong the open time and maintain dry film properties without using any VOCs. DES-incorporated paints were analyzed using ASTM Method D6886-18 with tetrahydrofuran (THF) as a solvent and ethylene glycol diethyl ether (EGDE) as an internal standard. Solids analysis was also conducted using ASTM D2369 to determine the density of wet paints. All analytes present at greater than 50 ppm were included. Methyl palmitate was used as a retention time marker by the South Coast Air Quality Management District (SCAQMD). Both material and coating VOC values based on the measured VOC fractions are depicted in the Table IX. VOC results indicate DESs, including NADESs, as novel open time extenders are suitable for addition to ultra-low-VOC and zero-VOC paints having a variety of finishes while maintaining outstanding paint properties and performances.

TABLE IX

| | | | Sample 01 | | | | | | | |
|---|---|---|---|---|---|---|---|---|---|---|
| | | | 0.5 | | | | | | | |
| | | | wt. % of | Sample 02 | Sample 03 | Sample 04 | Sample 05 | Sample 06 | Sample 07 | Sample 08 |
| | | | Propylene | 0.5 wt. % | 1.0 wt. % | 0.5 wt. % | 1.0 wt. % | 20 wt. % | 20 wt. % | 20 wt. % |
| | | Control 01 | glycol | of ChCl-U | of ChCl-U | of B-S | of B-S | of ChCl-U | of B-S | of ChCl-S |
| Code/ | Control 01 | DE Paint | within | within | within | within | within | within | within | within |
| Properties | DE Paint | (repeat) | Control 01 | Control 01 | Control 01 | Control 01 | Control 01 | control 01 | control 01 | control 01 |
| Density | 1281 | 1283 | 1283 | 1284 | 1283 | 1282 | 1284 | 1264 | 1213 | 1196 |
| (g/L) | | | | | | | | | | |
| Solid | 0.5207 | 0.5196 | 0.5187 | 0.5226 | 0.5222 | 0.5245 | 0.5224 | 0.6211 | 0.6168 | 0.6044 |
| fraction | | | | | | | | | | |
| Water | 0.4788 | 0.4797 | 0.4749 | 0.4769 | 0.4773 | 0.4749 | 0.4767 | 0.3776 | 0.2678 | 0.3346 |
| fraction | | | | | | | | | | |
| VOC | 0.0005 | 0.0007 | 0.0064 | 0.0005 | 0.0005 | 0.0006 | 0.0008 | 0.0013 | 0.1154 | 0.061 |
| fraction | | | | | | | | | | |
| Material | 0.7 | 0.9 | 8.2 | 0.6 | 0.6 | 0.8 | 1.1 | 1.6 | 140 | 73 |
| VOC (g/L) | | | | | | | | | | |
| Coating | 1.7 | 2.3 | 21 | 1.6 | 1.7 | 2 | 2.8 | 3.1 | 206 | 122 |
| VOC (g/L) | | | | | | | | | | |

A further embodiment of the invention may include a high-quality paint composition with DES additives to have improved pigment and colorant dispersion and stability. Poor dispersion may result in pigment settling and stability issues thereby having an adverse effect on color development, gloss, hiding, and pot life et al. Dispersants maintain pigment separation by two mechanisms: electrostatic stabilization and steric hinderance. Properly stabilized pigment dispersions may prevent flocculation and agglomeration. Heavily charged DESs may provide superior dispersion of inherently negatively or positively charged pigments in water via electrostatic repulsion. The impacts of the dispersion factors were quantified by the average diameter of various pigments in commercial dispersant and aqueous-DES systems using a PARTICA LA-950V2 laser scattering particle size distribution analyzer, with results shown in Table X (a particle size analysis on grind stage with various dispersants under 30 min mixing). DESs with lower amounts used in the grind provided equal performance to commercial dispersants in terms of particles size reduction and superior to samples without any dispersants. Pigment wetting may also be achieved simultaneously when dispersants (DESs) and solvents (i.e., water) adhere to exposed pigment surfaces by modifying the surface tension at the interface due to the super strong hygroscopic nature of DESs. For steric hinderance, a hydrogen bonding network formed with hydrogen-bond donors may improve the barrier to close contact between pigment particles.

TABLE X

| | | Sample G2 | | | |
|---|---|---|---|---|---|
| | Sample G1 | TAMOL ™ | Sample G3 | Sample G4 | Sample G5 |
| Ingredients/Quantity | No | 681 | C-U | B-S | C-S |
| (Parts) | dispersant | (35%) | (100%) | (100%) | (100%) |
| Dispersants | 0 | 22.7 | 4 | 4 | 4 |
| DOWANOL ™ DPnB | 10 | 10 | 10 | 10 | 10 |
| CARBOWET ® GA-100 | 5.4 | 5.4 | 5.4 | 5.4 | 5.4 |
| Ammonium Hydroxide | 0.5 | 0.5 | 0.5 | 0.5 | 0.5 |
| 26 Deg Baume | | | | | |
| FOAMSTAR ® ST 2445 | 0.6 | 0.6 | 0.6 | 0.6 | 0.6 |
| TRONOX ® CR-826 | 250 | 250 | 250 | 250 | 250 |
| titanium dioxide pigment | | | | | |
| MINEX ® 4 extender | 280 | 280 | 280 | 280 | 280 |
| POLYPHASE ® S99 | 7 | 7 | 7 | 7 | 7 |
| preservative | | | | | |
| Water | 95 | 95 | 95 | 95 | 95 |

Particle size analysis and property evaluation on the finished Grind

| | | | | | |
|---|---|---|---|---|---|
| Median size (micron) | 0.60785 | 0.0857 | 0.08561 | 0.0866 | 0.0873 |
| Mean size (micron) | 0.59375 | 0.08683 | 0.08684 | 0.08776 | 0.08845 |
| Standard deviation | 0.036 | 0.0089 | 0.009 | 0.0094 | 0.0099 |
| (micron) | | | | | |
| Liquid Grind status | Heavily | No | No | No | No |
| | settled | settling | settling | settling | settling |
| | overnight | overnight | overnight | overnight | overnight |
| Film Appearance on a | Cracks, | Smooth | Orange | Orange | Smooth |
| 3 mil drawdown | grits, and | | peel | peel | |
| | non- | | | | |
| | uniform | | | | |
| | sheen | | | | |

Further experimentation was also carried out on a water-based premium interior, ultra-low VOC, acrylic flat paint (DE control D-1) to evaluate the liquid paint and dry film properties by using several commercial dispersants and DESs in the grind stage at the same level of their active ingredients without changing any other components in the paint system. Table XI summarizes the results from the particle size analysis of the grind stage and properties of finished paints. DESs as co-dispersing agents applied in the grind stage performed equally and slightly better than those commercial candidates in terms of particles size reduction, KU stabilization and syneresis minimization over time under heat.

TABLE XI

| | Control | | | Sample | Sample |
|---|---|---|---|---|---|
| Code/Properties | D-1 | Sample D-2 | Sample D-3 | D-4 | D-5 |
| of Grinds and | TAMOL ™ | DISPEX ® | RHODOLINE ® | C-U | C-S |
| finished paints | 731A | AA 4144 EB | 111 | (100%) | (100%) |
| Median size | 7.13025 | 7.13178 | 4.20348 | 4.20452 | 7.12899 |
| (micron) of Grind | | | | | |
| Mean size | 7.11936 | 7.12265 | 4.26664 | 4.26666 | 7.10049 |
| (micron) of Grind | | | | | |
| Standard | 0.3860 | 0.3796 | 0.3157 | 0.3140 | 0.3817 |
| deviation (micron) | | | | | |
| of Grind | | | | | |
| Equilibrated KU of | 100.7 | 97.8 | 101.1 | 101 | 99.8 |
| finished paint | | | | | |
| Equilibrated ICI of | 1.283 | 1.233 | 1.296 | 1.337 | 1.321 |
| finished paint | | | | | |
| Equilibrated pH of | 9.28 | 9.25 | 9.06 | 8.97 | 8.97 |
| finished paint | | | | | |
| Contrast Ratio (%) | 96.18 | 96.35 | 96.1 | 96.24 | 96.51 |
| of finished paint | | | | | |
| Reflectance (%) of | 91.83 | 91.99 | 91.92 | 91.58 | 91.85 |
| finished paint | | | | | |
| Yellowness Index | 0.87 | 1.04 | 0.91 | 0.87 | 0.99 |
| of finished paint | | | | | |
| Gloss @ 20° of | 2.4 | 2.2 | 2.2 | 2.4 | 2.4 |
| finished paint | | | | | |
| Gloss @ 60° of | 12.6 | 11.9 | 12.4 | 13.3 | 13.3 |
| finished paint | | | | | |
| Gloss @ 85° of | 22.8 | 22.9 | 21.8 | 21.9 | 22.4 |
| finished paint | | | | | |
| KU 140° F. | 105.3 | 103.8 | 108.8 | 104.5 | 104.3 |
| 4 weeks | | | | | |
| ICI @ 140° F. | 1.175 | 1.204 | 1.15 | 1.033 | 0.921 |
| 4 weeks | | | | | |
| pH @ 140° F. | 8.23 | 8.24 | 8.22 | 8.05 | 7.95 |
| 4 weeks | | | | | |
| Contrast Ratio (%) @ | 96.92 | 97.06 | 96.32 | 97.3 | 96.53 |
| 140° F. 4 weeks | | | | | |
| Reflectance (%) @ | 91.73 | 92.09 | 91.73 | 91.59 | 91.49 |
| 140° F. 4 weeks | | | | | |
| Gloss @ 20° @ | 2.6 | 2.5 | 2.5 | 2.4 | 2.4 |
| 140° F. 4 weeks | | | | | |
| Gloss @ 60° @ | 13.7 | 13.1 | 13.2 | 12.8 | 12.6 |
| 140° F. 4 weeks | | | | | |
| Gloss @ 85° | 22.8 | 23.2 | 21.2 | 18.8 | 18.9 |
| 140° F. 4 weeks | | | | | |
| Syneresis (mm) @ | 4 | 4 | 5 | 4 | 3 |
| 140° F. 4 weeks | | | | | |

In addition, both pseudo-DESs and authentic DESs were post-added into ultra-low velvet paint (Control 03) followed by mixing with colorants (e.g., Rock ‘n’ Rose DE5060, Faraway Sky DE5942 and Whole Wheat DE6124) as shown in FIG. 7, FIG. 8, and FIG. 9. Moreover, an experimental eggshell ultra-deep paint (Control 04) was combined with 4 and 8 pph of ChCl to investigate its stabilizing effect on the pigment, with data and pictures shown in Table XII and FIG. 10, respectively. ChCl itself and ChCl-based [word missing here?], both authentic NADESs and pseudo-DESs, demonstrated greater potential as stabilizing media with reduced color floating and syneresis than other candidates. It may be ascribed to the formation of stronger hydrogen bonding interactions among pigments & colorants, DES molecules and latex particles, which result in a three-dimensional associative network and thereby create stable paints for use in a high variety of geographical markets.

FIG. 7 illustrates a color floating test at 120° F. (48.89° C.) of paints with post-added 6 pph of pseudo-DESs and their single ingredients.

FIG. 8 illustrates a color floating test at room temperature (25-30° C.) of paints with post-added 6 pph of pseudo-DESs and their single ingredients.

FIG. 9 illustrates a color floating test at room temperature (25-30° C.) of paints with post-added 6 pph of authentic NADESs.

FIG. 10 illustrates an oven stability test at temperature of 140° F. (60° C.) of experimental paints with post-added 4 and 8 pph of ChCl. Table XII depicts liquid properties of paints out of oven at 140° F. for 2 and 4 weeks as shown in FIG. 10.

TABLE XII

| | | Prototype 25 | Prototype 26 |
|---|---|---|---|
| | Control 04 | Post-added | Post-added |
| | DE | 4 pph of | 8 pph of |
| | Experimental | ChCl into | ChCl into |
| Code/Properties | Paint | control 04 | control 04 |
| Equilibrated KU | 84.4 | 85.4 | 85.3 |
| Equilibrated ICI | 0.817 | 0.721 | 0.713 |
| Equilibrated pH | 8.13 | 8.18 | 8.16 |
| KU @140° F. | 87.2 | 84.5 | 85.0 |
| 4 week | | | |
| ICI @140° F. | 0.763 | 0.787 | 0.954 |
| 4 week | | | |
| pH @140° F. | 7.18 | 7.16 | 7.16 |
| 4 week | | | |
| Syneresis (mm) | 24 | 12 | 9 |
| @140° F. 2 week | | | |
| Syneresis (mm) | 39 | 32 | 26 |
| @140° F. 4 week | | | |
| Settling @140° F. | None | None | None |
| 2 and 4 week | | | |

Various characteristics, advantages, embodiments, and/or examples relating to the invention have been described in the foregoing description with reference to the accompanying drawings. However, the above description and drawings are illustrative only. The invention is not limited to the illustrated embodiments and/or examples, and all embodiments and/or examples of the invention need not necessarily achieve every advantage or purpose, or possess every characteristic, identified herein. Accordingly, various changes, modifications, or omissions may be effected by one skilled in the art without departing from the scope or spirit of the invention, which is limited only by the appended claims. Although example materials and dimensions have been provided, the invention is not limited to such materials or dimensions unless specifically required by the language of a claim. Elements and uses of the above-described embodiments and/or examples can be rearranged and combined in manners other than specifically described above, with any and all permutations within the scope of the invention, as limited only by the appended claims.

Unless the phrase ‘means for’ or ‘step for’ appears in a particular claim or claim limitation, such claim or claim limitation should not be interpreted to invoke 35 U.S.C. § 112(f).

Use of “and” herein to join elements in a list forms a group of all elements of the list. For example, a list described as comprising A, B, and C defines a list that includes A, includes B, and includes C. Use of “or” herein to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are not exhaustive, that is, lists are not limited to the stated elements and may be combined with other elements not specifically stated in a list.

In the claims, various portions are prefaced with letter or number references for convenience. However, use of such references does not imply a temporal or ordered relationship not otherwise required by the language of the claims.

Unless otherwise stated, any range of values disclosed herein sets out a lower limit value and an upper limit value, and such ranges include all values and ranges between and including the limit values of the stated range, and all values and ranges substantially within the stated range as defined by the order of magnitude of the stated range.

The inventors hereby state their intent to rely on the Doctrine of Equivalents to determine and assess the reasonably fair scope of their invention as pertains to any apparatus not materially departing from but outside the literal scope of the invention as set out in the following claims.

We claim:

1. A coating composition comprising:
a pigment;
a binder;
water; and
a deep eutectic solvent blend comprising an ionic solvent with at least one hydrogen bond donor and at least one hydrogen bond acceptor, wherein the melting point of the deep eutectic solvent blend is lower than either individual component.

2. The coating composition of claim 1 further comprising a dispersing agent.

3. The coating composition of claim 1 further comprising a wetting agent.

4. The coating composition of claim 1 further comprising a neutralizing agent.

5. The coating composition of claim 1 wherein the total solid content of the DES system is more than about 70% by weight.

6. The coating composition of claim 1 wherein the melting temperature of the composition is below 100° C.

7. The coating composition of claim 1 wherein the melting temperature of the composition is most preferably not more than 50° C.

8. The coating composition of claim 1 further comprising a pseudo deep eutectic solvent blend having same ingredients in the same mole ratio as the DES system without forming eutectic mixtures, wherein the total solid content of the pseudo deep eutectic solvent blend is more than about 70% by weight.

9. The coating composition of claim 1 further comprising at least one additive selected from the group consisting of: dispersing agents, wetting agents, leveling agents, neutralizing agents, rheology modifiers, freeze/thaw stabilizers, corrosion inhibitors, biocides, mildewcides, coalescing agents, and defoamers.

10. The coating composition of claim 1 wherein the pigment is selected from the group consisting of: primary and extender white pigments, metallic pigments, colored pigments in both inorganic and organic compounds, and functional pigments providing slip resistance, antifouling protection against mold, mildew or bacteria, UV stabilization, corrosion resistance or other desired properties.

11. The coating composition of claim 1 wherein the binder is one of: water-based acrylics, alkyds, epoxies, polyurethanes, polyesters, silicones, and Vinyls.

12. The coating composition of claim 1 wherein the organic salt is a quaternary ammonium salt.

13. The coating composition of claim 1 wherein the organic salt is a quaternary imidazolium salt.

14. The coating composition of claim 1 wherein the organic salt is a phosphonium salts.

15. The coating composition of claim 1 wherein the organic salt is a tertiary sulfonium salts.
